(19) United States
(12) Patent Application Publication
(10) Pub. No.: US 2008/0182627 A1
(43) Pub. Date: Jul. 31, 2008

(54) PHONE AVAILABILITY INDICATION

(75) Inventor: Staffan LINCOLN, Lund (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/627,487

(22) Filed: Jan. 26, 2007

(51) Int. Cl. H04M 1/00; H04B 1/38

(52) U.S. Cl. 455/566; 455/550.1

(57) ABSTRACT

A communication device is provided that may include a motion detector. The motion detector in the communication device may detect motion and transmit a signal in response to the detected motion. Other communication devices may receive a transmitted presence information signal and display information indicating that a user of a communication device is available.

### TECHNICAL FIELD OF THE INVENTION

Implementations described herein relate generally to communication devices, and more particularly, to detecting user availability.

### DESCRIPTION OF RELATED ART

Communication devices, such as mobile terminals, may be used by individuals for communicating with users of other communication devices. For example, a communication device may be used to place/receive calls and send/receive text messages to/from other communication devices having unique identifiers, e.g., phone numbers. A feature of communication devices typically includes providing a contact list of phone numbers. However, there is no way of determining and indicating the current availability of the users' of the communication devices in the contact list.

### SUMMARY

According to one aspect, a communication device is provided. The communication device comprises a motion detector for determining that the communication device is in motion; and logic configured to: transmit a signal in response to the motion detector determining that the communication device is in motion.

Additionally the motion detector includes at least one of an accelerometer and a gyrometer.

Additionally, the transmitted signal includes information indicating that a user of the communication device is available.

Additionally, the communication device comprises a mobile phone.

Additionally, the logic is further configured to receive a signal indicating that a user of a second communication device is available.

According to another aspect, a method may be provided. The method may comprise detecting motion associated with a communication device; and transmitting a signal to a network in response to detected motion associated with the communication device.

Additionally, the transmitted signal includes information indicating that a user of the communication device is available.

Additionally, the transmitted signal includes information identifying the communication device.

Additionally, the detecting motion includes detecting accelerated motions of the communication device.

Additionally, the method further comprises receiving and displaying information that a user of a second communication device is available.

According to another aspect, a communication device is provided. The communication device comprises a display; a memory to store a contact list of parties, wherein at least some of the parties in the contact list are associated with a mobile phone; and logic configured to: receive a signal indicating that a first one of the parties in the contact list is available, and control the display to display information indicating that the first party is available.

Additionally, the logic is further configured to control the display to display information from the contact list associated with each of the available parties.

Additionally, the displayed information indicating that the party is available comprises at least one of text information or a graphical icon.

Additionally, the logic is further configured to control the display to display a scrollable list of available parties.

Additionally, the communication device comprises a mobile phone.

According to another aspect, a method is provided. The method comprises storing a contact list of parties, wherein at least some of the parties in the contact list are associated with a mobile phone; receiving a signal indicating that at least one of the parties in the contact list is available; and displaying information indicating that the at least one party is available.

Additionally, the method further comprises storing a name and telephone number in the contact list associated with each party.

Additionally, the method further comprises displaying at least one of the stored name or number associated with the at least one available party.

Additionally, the displayed information indicating that the at least one party is available comprises text information.

Additionally, the text information indicating that the at least one party is available is displayed on a mobile phone.

According to another aspect, a network device is provided. The network device comprises a memory for storing a plurality of contact lists of parties, wherein each contact list is associated with a communication device; and logic configured to: receive a signal from at least one of a plurality of communication devices, wherein the signal indicates that an identified communication device is in motion, and transmit a signal to each communication device that includes the identified communication device in its associated contact list.

Additionally, the transmitted signal to each communication device indicates that a user of the identified communication device is present.

Additionally, the logic is further configured to search the stored contact lists for the identified communication device.

Additionally, the logic is further configured to receive a contact list from an associated communication device.

Additionally, each communication device comprises a mobile phone.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 illustrates an exemplary system;

FIG. 2 illustrates an exemplary server shown in FIG. 1;

FIG. 3 is a diagram of an exemplary implementation of a communication device;

FIG. 4 illustrates an exemplary functional diagram of the communication device of FIG. 3;

FIG. 5 illustrates an exemplary contact list data structure;

FIG. 6 illustrates an exemplary flow diagram of detecting and displaying presence information; and

FIGS. 7A-7C illustrate exemplary displays of presence information.

### DETAILED DESCRIPTION OF THE INVENTION

The following detailed description of the embodiments refers to the accompanying drawings. The same reference numbers in different drawings may identify the same or similar elements. Also, the following detailed description does not limit the embodiments.

### Exemplary System

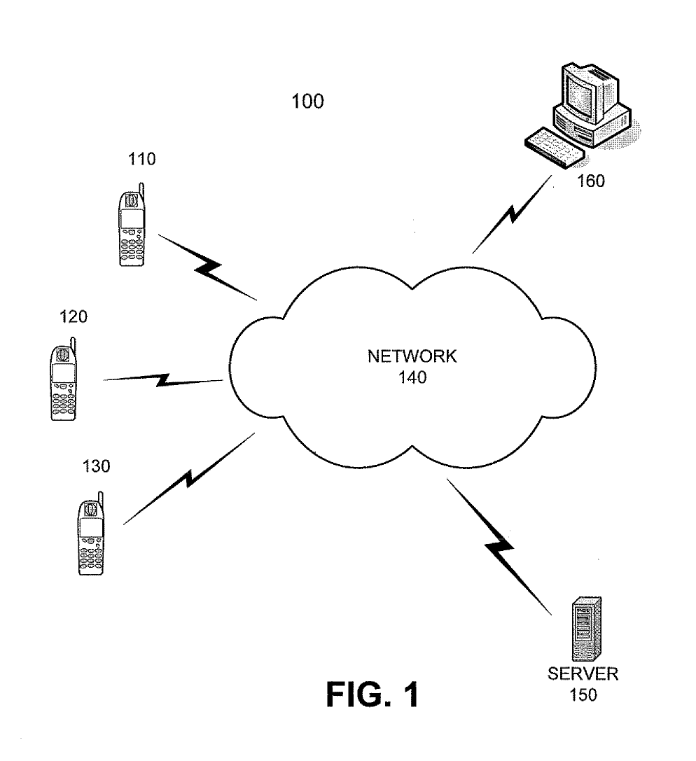

FIG. 1 is a diagram of an exemplary system 100 in which methods and systems described herein may be implemented. System 100 may include communication devices 110, 120 and 130, server 150 and computer 160, connected via network 140. It should be understood that system 100 may include other numbers of communication devices, networks and servers.

Methods and systems described herein may be implemented in the context of a communication device, such as one of communication devices 110-130. As used herein, the term “communication device” may include a cellular radiotelephone; a Personal Communications System (PCS) terminal that may combine a cellular radiotelephone with data processing, facsimile and data communications capabilities; a personal digital assistant (PDA) that can include a radiotelephone, pager, Internet/Intranet access, Web browser, organizer, calendar and/or a global positioning system (GPS) receiver, a radio (AM/FM) receiver; and a laptop and/or palmtop receiver or other appliance that includes a radiotelephone transceiver.

Network 140 may include one or more networks, such as a cellular network, a satellite network, the Internet, a telephone network, such as the Public Switched Telephone Network (PSTN), a metropolitan area network (MAN), a wide area network (WAN), a local area network (LAN), or a combination of networks. Communication devices 110-130 and computer 160 may communicate with each other over network 140 via wired, wireless or optical connections.

In an exemplary implementation, network 140 includes a cellular network used for transmitting data between communication devices 110-130, server 150 and computer 160. For example, components of a cellular network may include base station antennas (not shown) that transmit and receive data from mobile terminals within their vicinity. Other components of a cellular network, for example, may include base stations (not shown) that connect to the base station antennas and communicate with other devices, such as switches and routers (not shown) in accordance with known techniques.

Server 150 may include one or more processors or microprocessors enabled by software programs to perform functions, such as data storage and transmission, and interfacing with other servers (not shown), communication devices 110-130 and computer 160, for example. Server 150 may also include a data storage memory, such as a random access memory (RAM) or another dynamic storage device that stores information, such as contact lists and phone presence information, as described below.

Computer 160 may include one or more processors or microprocessors enabled by software programs to perform functions, such as data storage and transmission, codec conversion, and communications with server 150 and communication devices 110-130, for example. Computer 160 may include software to enable communications over network 140 and/or the Internet. Computer 160 may also include a data storage memory, such as a random access memory (RAM) or another dynamic storage device that stores information. Computer 160 may also include a keyboard for entering data, a mouse for selecting data or pointing to data, and a CRT or flat panel display monitor.

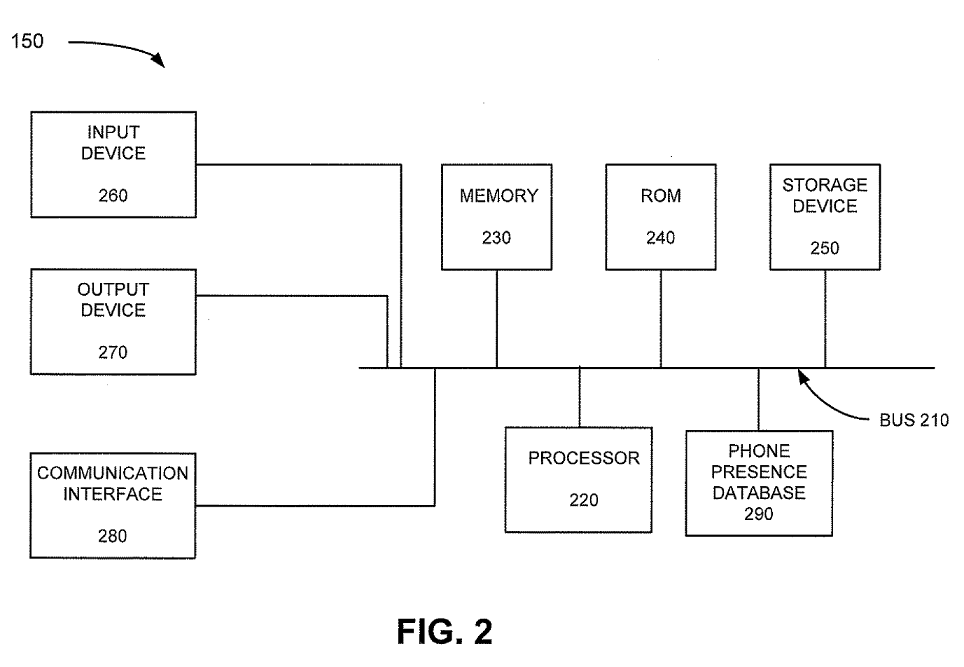

FIG. 2 is a diagram of an exemplary configuration of server 150. Server 150 may include bus 210, processor 220, a memory 230, a read only memory (ROM) 240, a storage device 250, an input device 260, an output device 270, a communication interface 280, and a phone presence database 290. Server 150 may also include one or more power supplies (not shown). One skilled in the art would recognize that server 150 may be configured in a number of other ways and may include other or different elements.

Bus 210 permits communication among the components of server 150. Processor 220 may include any type of processor, microprocessor, or processing logic that may interpret and execute instructions. Processor 220 may also include logic that is able to decode media files, such as audio files, video files, etc., and generate output to, for example, a speaker, a display, etc. Memory 230 may include a random access memory (RAM) or another dynamic storage device that stores information and instructions for execution by processor 220. Memory 230 may also be used to store temporary variables or other intermediate information during execution of instructions by processor 220.

ROM 240 may include a ROM device and/or another static storage device that stores static information and instructions for processor 220. Storage device 250 may include a magnetic disk or optical disk and its corresponding drive and/or some other type of magnetic or optical recording medium and its corresponding drive for storing information and instructions. Storage device 250 may also include a flash memory (e.g., an electrically erasable programmable read only memory (EEPROM)) device for storing information and instructions.

Input device 260 may include one or more mechanisms that permit a user to input information to server 150, such as a keyboard, a mouse, a microphone, a pen, voice recognition and/or biometric mechanisms, etc. Output device 270 may include one or more mechanisms that output information to the user, including a display, a printer, etc.

Communication interface 280 may include any transceiver-like mechanism that enables server 150 to communicate with other devices and/or systems. For example, communication interface 280 may include a modem or an Ethernet interface to a LAN. In addition, communication interface 280 may include other mechanisms for communicating via a network, such as network 140. For example, communication interface 280 may include one or more radio frequency (RF) transmitters, and one or more RF receivers and antennas for transmitting and receiving RF signals. Communication interface 280 may also receive and transmit phone presence information signals as described below.

Phone presence database 290 may include a plurality of contact lists of information. For example, each communication device 110-130 may have an associated contact list stored in phone presence database 290 that may contain names and numbers associated with other communication devices. Phone presence database 290 may also store information relating to the presence or availability of users of communication devices. Processor 220 and/or phone presence database 290 may perform processing for receiving, identifying and transmitting phone presence information signals. For example, processor 220 and/or phone presence database 290 may receive and identify a presence information signal transmitted from a communication device, may search for the identified communication device in the contact list(s) stored in phone presence database 290, and may transmit a presence information signal to other communication devices that may include the identified communication device in their associated contact list.

According to an exemplary implementation, server 150 may perform various processes in response to processor 220 executing sequences of instructions contained in memory 230. Such instructions may be read into memory 230 from another computer-readable medium, such as storage device 250, or from a separate device via communication interface 280. It should be understood that a computer-readable medium may include one or more memory devices or carrier waves. Execution of the sequences of instructions contained in memory 230 causes processor 220 to perform the acts that will be described hereafter. In alternative embodiments, hardwired circuitry may be used in place of or in combination with software instructions to implement aspects of the embodiments. Thus, the systems and methods described herein are not limited to any specific combination of hardware circuitry and software.

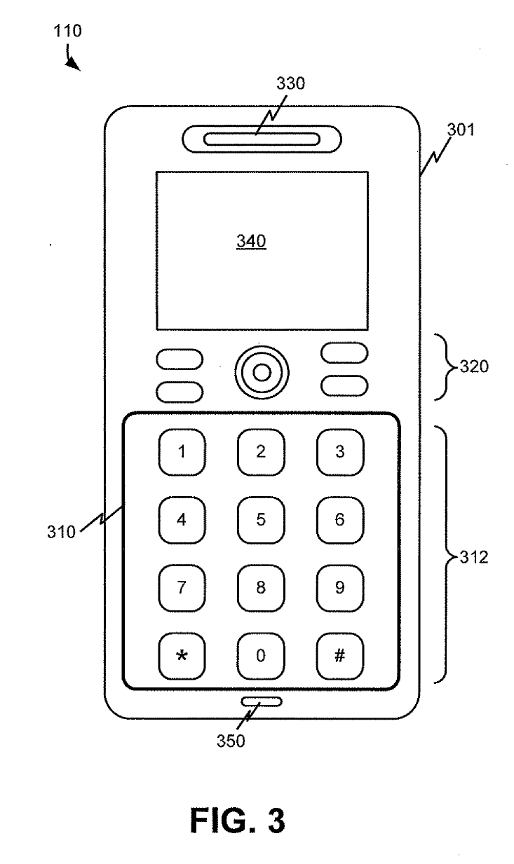

FIG. 3 is a diagram of an exemplary implementation of a communication device 110 consistent with the principles of the embodiments. Communication device 110 may include housing 301, keypad 310, control keys 320, speaker 330, display 340, and microphone 350. Housing 301 may include a structure configured to support and protect devices and components used in communication device 110. For example, housing 301 may be formed from plastic, metal, or composite and may be configured to support keypad 310, control keys 320, speaker 330, display 340 and microphone 350.

Keypad 310 may include devices and/or logic that can be used to operate communication device 110. Keypad 310 may further be adapted to receive user inputs, directly or via other devices, such as a stylus for entering information into communication device 110. In one implementation, communication functions of communication device 110 may be controlled by activating keys 312. Implementations of keys 312 may have key information associated therewith, such as numbers, letters, symbols, etc. A user may interact with keys 312 to input key information into communication device 110. For example, a user may operate keys 312 to enter digits, commands, and/or text, into communication device 110, which may create, store and display information in a contact list. Designated functions of keys 312 may also form and/or manipulate images that may be displayed on display 340.

Control keys 320 may include buttons that permit a user to interact with communication device 110 to cause communication device 110 to perform specified actions, such as to display phone presence information in a contact list via display 340, scroll through the contact list, select one or more of the displayed numbers on the contact list, place a call to the selected number, etc.

Speaker 330 may include a device that provides audible information to a user of communication device 110. Speaker 330 may be located anywhere on communication device 110 and may function, for example, as an earpiece when a user communicates using communication device 110. Speaker 330 may also function as an output device for music and/or audio information associated with games and/or video images played on communication device 110.

Display 340 may include a device that provides visual images to a user. For example, display 340 may provide a contact list of parties that includes phone presence information. Display 340 may also provide graphic information regarding incoming/outgoing calls, text messages, games, phonebooks, the current date/time, volume settings, etc., to a user of communication device 110. Implementations of display 340 may include black and white or color flat panel displays, such as liquid crystal displays.

Microphone 350 may include a device that converts speech or other acoustic signals into electrical signals for use by communication device 110. Microphone 350 may be located anywhere on communication device 110 and may be configured, for example, to convert spoken words or phrases into electrical signals for use by communication device 110.

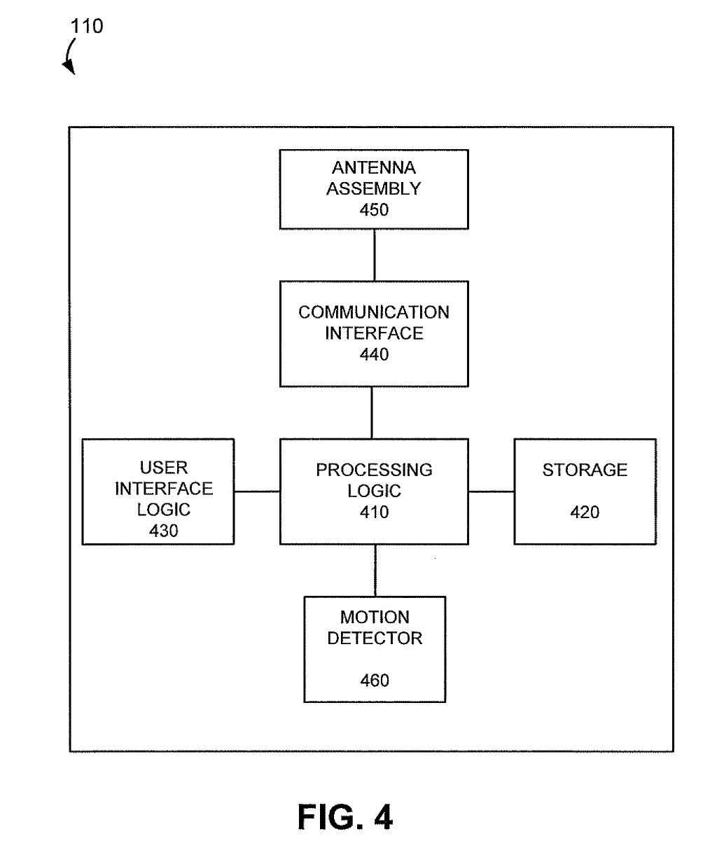

FIG. 4 illustrates an exemplary functional diagram of a communication device, such as communication device 110, consistent with the principles of the embodiments. As shown in FIG. 4, communication device 110 may include processing logic 410, storage 420, user interface logic 430, communication interface 440, antenna assembly 450 and motion detector 460.

Processing logic 410 may include a processor, microprocessor, an application specific integrated circuit (ASIC), field programmable gate array (FPGA), or the like. Processing logic 410 may include data structures or software programs to control operation of communication device 110 and its components. Implementations of communication device 110 may use an individual processing logic component or multiple processing logic components, such as processing logic components operating in parallel.

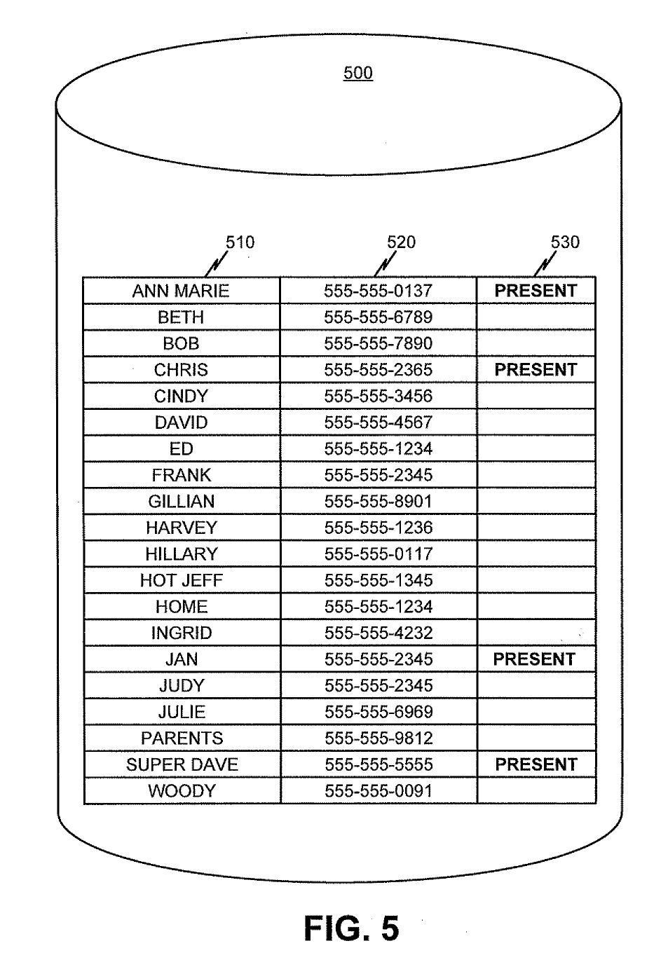

Storage 420 may include a random access memory (RAM), a read only memory (ROM), and/or another type of memory to store data and instructions that may be used by processing logic 410. Storage 420 may also store a contact list that may include phone presence information as described in FIG. 5.

User interface logic 430 may include mechanisms, such as hardware and/or software, for inputting information to communication device 110 and/or for outputting information from communication device 110. For example, user interface logic 430 may include keys 312 and control keys 320.

Communication interface 440 may include, for example, a transmitter that may convert base band signals from processing logic 410 to radio frequency (RF) signals and/or a receiver that may convert RF signals to base band signals. Alternatively, communication interface 440 may include a transceiver to perform functions of both a transmitter and a receiver. Communication interface 440 may connect to antenna assembly 450 for transmission and reception of the RF signals. Antenna assembly 450 may include one or more antennas to transmit and receive RF signals over the air.

Motion detector 460 may include, for example, an accelerometer, a gyrometer, a gyroscope or some other motion sensitive device that may generate an electrical signal in response to detecting motion of communication device 110. For example, accelerated movements of communication device 110, which result from a user operating communication device 110, may cause motion detector 460 to generate a signal. Motion detector 460 may also include logic to provide a signal to processing logic 410 for transmission of motion information or “phone presence information” to other communication devices.

As will be described in detail below, communication device 110, consistent with the embodiments described herein, may perform certain operations relating to detecting motion or “presence” of a user and to transmit/receive and display presence information. Communication device 110 may perform such operations in response to processing logic 410 executing software instructions associated with a contact list application contained in a computer-readable medium, such as storage 420. A computer-readable medium may be defined as a physical or logical memory device and/or carrier wave.

The software instructions may be read into storage 420 from another computer-readable medium or from another device via communication interface 440. The software instructions contained in storage 420 may cause processing logic 410 to perform processes that will be described later. Alternatively, hardwired circuitry may be used in place of or in combination with software instructions to implement processes consistent with the principles described herein. Thus, implementations consistent with the embodiments described herein are not limited to any specific combination of hardware circuitry and software.

### Exemplary Contact List Data Structure

FIG. 5 illustrates an exemplary contact list 500 consistent with the principles of the embodiments described herein. Contact list 500 may include a computer-readable medium that can be used to store information in a machine-readable format. In one implementation, contact list 500 may store information that is used to form a displayable list on display 340. Exemplary contact list 500 may be stored in storage 420 of communication device 110, and may also be stored in phone presence database 290 of server 150. Contact list 500 may be transmitted to and/or received from server 150 and/or computer 160. For example, information contained in contact list 500 may be entered via computer 160, and downloaded into communication device 110, and information in contact list 500 that may be entered via communication device 110, may be downloaded and stored into server 150. Contact list 500 may also be used to form displayable names and/or numbers when an incoming call is received by communication device 110.

Contact list 500 may include a list of names, numbers and other information that may be arranged in individual entries (shown here as rows) in fields (shown here in columns), such as a name field 510, a number or caller identifier (CID) field 520, and a presence field 530. Information in contact list 500 may be arranged in any format.

Name field 510 may include information that identifies a user associated with a specific communication device. The information in name field 510 may be entered by a user of communication device 110 through a contact list menu for example, using keys 312 on keypad 310. The names in name field 510 may be stored and displayed in alphabetical order, for example. Once a name is entered in name field 510, a user may save the name using control keys 320 and/or may be prompted to enter a phone number associated with the name. Also, for example, a number may be dialed or entered by a user of communication device 110, and then the user may be automatically prompted to enter and save a name associated with the number in the contact list 500. In this example, a user may then enter a name that may be stored in name field 510 with the associated number in contact list 500.

Number field 520 may include information that identifies a phone number with an associated name in name field 510, for example. Number field 520 may include information, such as a phone number, an e-mail address, etc., that is uniquely associated with a communication device, for example. The number stored in number field 520, for example, may also be referred to as a caller identifier (CID).

Presence field 530 may include information that indicates that the user of the corresponding communication device 110 is “present.” In other implementations, a graphical icon may be used in presence field 530 to indicate presence. For example, a “smiley face” icon may be used. In one implementation, information in presence field 530 may be text information, such as the word “Present.” Presence information may be dynamically changed by processing logic 410 in response to received phone presence information signals, for example.

### Exemplary Phone Presence Processing

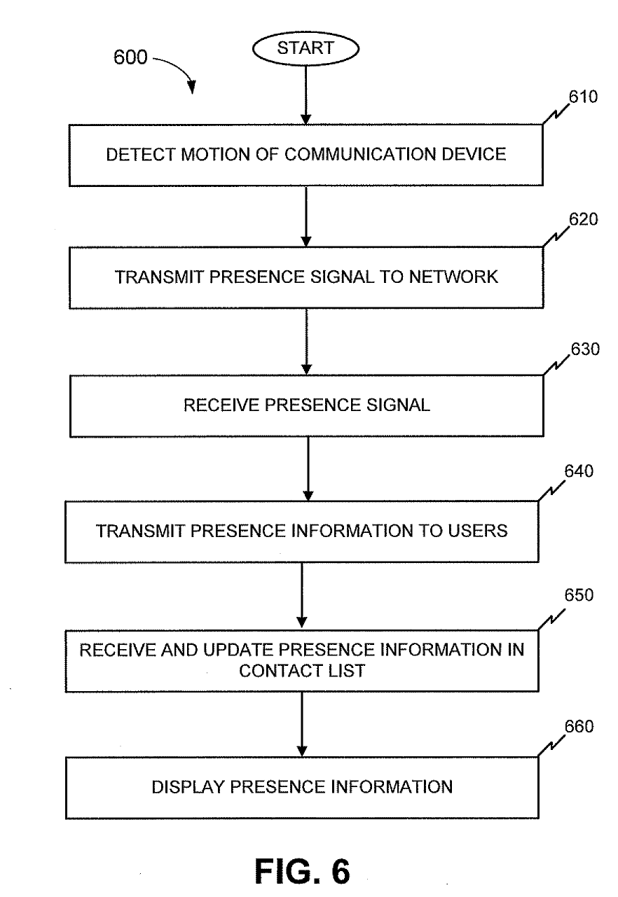

FIG. 6 is a flowchart of an exemplary process 600 consistent with implementations of the embodiments to detect motion and display the status of a communications device 110. Process 600 may begin, for example, when motion detector 460 detects motion of communication device 110 (act 610). For example, if a user of communication device 110 is carrying or using communication device 110, changes in the motion of communication device 110 may be detected by motion detector 460. As described above, motion detector 460 may be in the form of an accelerometer, a gyroscope or some other motion detecting device (e.g. one or more mini gyroscopes). After detecting motion of the communication device 110, a presence information signal is transmitted to network 140 (act 620). For example, communication interface 440 may transmit a presence signal via antennae assembly 450.

The transmitted presence information signal may then be received by devices in the network (act 630). For example, server 150 may receive the presence information signal from communication device 110 via network 140. Server 150 may store a contact list 500 associated with each communication device 110, 120 and 130, as shown for communication device 110 in FIG. 5. After receiving a presence information signal from a communication device 110, server 150 may search the stored contact lists 500 in phone presence database 290, and transmit presence information to other communication devices (act 640). For example, if communication devices 120 and 130 include communication device 110 (e.g. a telephone number or other CID associated with communication device 110) in their respective contact lists, server 150 may send both communication devices 120 and 130 a presence information signal via network 140 indicating that the user of communication device 110 is available or present. That is, processor 220 may access contact lists 500 stored in phone presence database 290 to identify each contact list that includes a CID corresponding to communication device 110. Server 150 may then transmit a presence information signal to each of these devices.

The transmitted presence information signal (in act 640) may then be received and the corresponding presence information may be updated in the contact list of the receiving communication device (e.g. communication devices 120 and 130 in this example) (act 650). For example, communication devices 120 and 130 may receive presence information that the user of communication device 110 is present. As shown in FIG. 3, a “Present” label/identifier may be added in column 530 of contact list 500 stored in communication devices 120 and 130 to update the status of the user of communication device 110.

Once the presence information in contact list 500 has been updated, the presence information may then be displayed (act 660). For example, display 340 of each of communication devices 120 and 130 may display information indicating that a user of another communication device (i.e. communication device 110 in this example) is “Present.” Communication device 110, which transmitted its presence information in this example, may similarly receive phone presence information from other communication devices. Phone presence information may also be updated on a continuous basis or at predetermined intervals. For example, if no motion has been detected within a predetermined time period, one hour for example, communication device 110 may transmit a signal indicating that a user is not available or present. The signal indicating that a user is not available may then be received by devices in network 140, where this information may be updated in contact list 500 and displayed to a user via display 340.

In other embodiments, phone presence information signals may be transmitted between communication devices in a peer-to-peer manner. For example, communication device 110 may transmit its presence information signal directly to each communication device in its stored contact list 500. Communication device 110 may also receive phone presence information signals directly from other communication devices in a similar manner.

### EXAMPLES

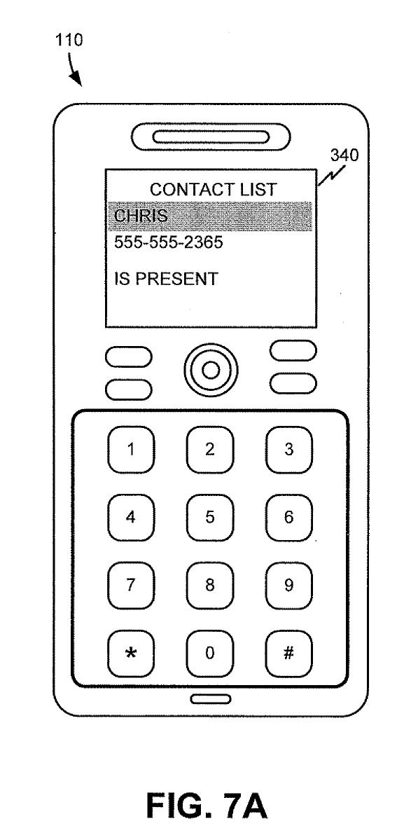

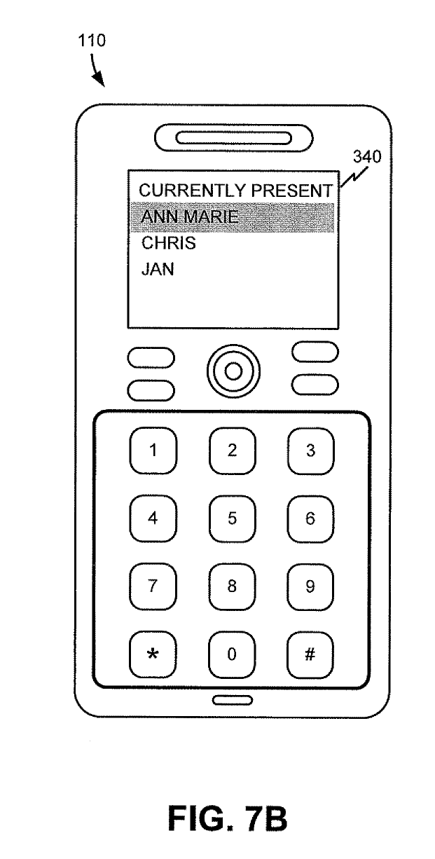

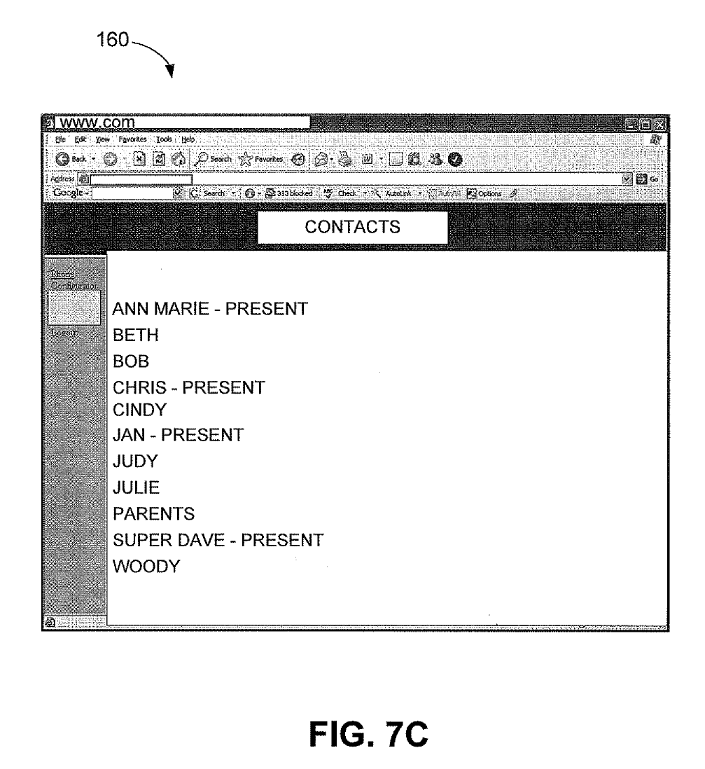

FIGS. 7A-7C illustrate exemplary displays of presence information that may be generated using the method described in FIG. 6. FIG. 7A shows an exemplary display 340 of communication device 110. The exemplary display 340 contains the contact name “Chris,” the associated telephone number 555-555-2365 and text “IS PRESENT.” For example, “Chris” may be name of the user of communication device 120. A user of communication device 110 may be shown presence information via display 340 indicating that “Chris” is present with his associated communication device 120.

FIG. 7B shows another exemplary display 340 of communication device 110 generated using the method described in FIG. 6. In this example, all the names in contact list 500 that are “currently present” may be displayed. In this example, the contacts “Ann Marie,” “Chris” and “Jan” may be displayed to the user of communication device 110 via display 340. As it is likely that these “currently present” contacts are currently using or carrying their respective communication devices, a user may be motivated to call one of these contacts. For example, using control keys 320, a user may highlight “Ann Marie” or one of the other contacts and call the associated number by selecting the highlighted choice, for example.

FIG. 7C shows another exemplary display of presence information generated by the method of FIG. 6. In this example, computer 160 may display presence information within a contact list. For example, contacts “Ann Marie,” “Chris,” “Jan” and “Super Dave” are shown as “Present” to a user of computer 160. A user of computer 160 may then desire to communicate with one of the presently available contacts by sending a text message, for example.

### CONCLUSION

Implementations consistent with the embodiments described herein may provide phone presence detection. Implementations described herein may also produce a displayable contact list to a user of a communication device that provides phone presence information.

The foregoing description of preferred embodiments of the embodiments provides illustration and description, but is not intended to be exhaustive or to limit the embodiments to the precise form disclosed. Modifications and variations are possible in light of the above teachings or may be acquired from practice of the implementations.

While series of acts have been described with regard to FIG. 6, the order of the acts may be modified in other implementations consistent with the principles of the embodiments. Further, non-dependent acts may be performed in parallel.

It will be apparent to one of ordinary skill in the art that aspects of the implementations, as described above, may be implemented in many different forms of software, firmware, and hardware in the implementations illustrated in the figures. The actual software code or specialized control hardware used to implement aspects consistent with the principles of the embodiments is not limiting of the embodiments. Thus, the operation and behavior of the aspects were described without reference to the specific software code—it being understood that one of ordinary skill in the art would be able to design software and control hardware to implement the aspects based on the description herein.

It should be emphasized that the term “comprises/comprising” when used in this specification and/or claims is taken to specify the presence of stated features, integers, steps or components but does not preclude the presence or addition of one or more other features, integers, steps, components or groups thereof.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A communication device comprising:
a motion detector for determining that the communication device is in motion; and
logic configured to:
transmit a signal in response to the motion detector determining that the communication device is in motion.

2. The communication device of claim 1, wherein the motion detector includes at least one of an accelerometer or a gyrometer.

3. The communication device of claim 2, wherein the transmitted signal includes information indicating that a user of the communication device is available.

4. The communication device of claim 3, wherein the communication device comprises a mobile phone.

5. The communication device of claim 3, wherein the logic is further configured to:
receive a signal indicating that a user of a second communication device is available.

6. A method comprising:
detecting motion associated with a communication device; and
transmitting a signal to a network in response to detected motion associated with the communication device.

7. The method of claim 6, wherein the transmitted signal includes information indicating that a user of the communication device is available.

8. The method of claim 7, wherein the transmitted signal includes information identifying the communication device.

9. The method of claim 6, wherein the detecting motion includes detecting accelerated motions of the communication device.

10. The method of claim 6, further comprising:
receiving and displaying information that a user of a second communication device is available.

11. A communication device comprising:
a display;
a memory to store a contact list of parties, wherein at least some of the parties in the contact list are associated with a mobile phone; and
logic configured to:
receive a signal indicating that a first one of the parties in the contact list is available, and
control the display to display information indicating that the first party is available.

12. The communication device of claim 11, wherein the logic is further configured to:
control the display to display information from the contact list associated with each of the available parties.

13. The communication device of claim 11, wherein the displayed information indicating that the party is available comprises at least one of text information or a graphical icon.

14. The communication device of claim 13, wherein the logic is further configured to: control the display to display a scrollable list of available parties.

15. The communication device of claim 11, wherein the communication device comprises a mobile phone.

16. A method comprising:
storing a contact list of parties; wherein at least some of the parties in the contact list are associated with a mobile phone;
receiving a signal indicating that at least one of the parties in the contact list is available; and
displaying information indicating that the at least one party is available.

17. The method of claim 16, further comprising:
storing a name and telephone number in the contact list associated with each party.

18. The method of claim 17, further comprising:
displaying at least one of the stored name or number associated with the at least one available party.

19. The method of claim 16, wherein the displayed information indicating that the at least one party is available comprises text information.

20. The method of claim 19, wherein the text information indicating that the at least one party is available is displayed on a mobile phone.

21. A network device comprising:
a memory for storing a plurality of contact lists of parties, wherein each contact list is associated with a communication device; and
logic configured to:
receive a signal from at least one of a plurality of communication devices, wherein the signal indicates that an identified communication device is in motion, and
transmit a signal to each communication device that includes the identified communication device in its associated contact list.

22. The network device of claim 21, wherein the transmitted signal to each communication device indicates that a user of the identified communication device is present.

23. The network device of claim 21, wherein the logic is further configured to:
search the stored contact lists for the identified communication device.

24. The network device of claim 21, wherein the logic is further configured to:
receive a contact list from an associated communication device.

25. The network device of claim 21, wherein each communication device comprises a mobile phone.
